(19) United States
(12) Patent Application Publication
(10) Pub. No.: US 2026/0081976 A1
(43) Pub. Date: Mar. 19, 2026

(54) CROWD-SOURCED AERIAL VEHICLE DETECTION AND TRACKING SYSTEM USING DISTRIBUTED MOBILE DEVICE SENSORS

(71) Applicant: PLURIBUS Inc., McLean, VA (US)

(72) Inventor: James Allen Samuel, Fairfax, VA (US)

(73) Assignee: PLURIBUS Inc., McLean, VA (US)

(21) Appl. No.: 19/399,063

(22) Filed: Nov. 24, 2025

Related U.S. Application Data
(63) Continuation-in-part of application No. 18/174,946, filed on Feb. 27, 2023, now Pat. No. 12,483,634.
Application No. 18/174,946 is a continuation of application No. 17/443,670, filed on Jul. 27, 2021, now Pat. No. 11,595,486.
Application No. 17/443,670 is a continuation-in-part of application No. 16/949,875, filed on Nov. 18, 2020, now abandoned.
(60) Provisional application No. 62/901,997, filed on Sep. 18, 2019.
(60) Provisional application No. 63/056,871, filed on Jul. 27, 2020.

(51) Int. Cl. H04L 67/52; G01C 21/34; G01C 21/36; G08B 5/22; G08B 21/02; G08B 25/10; H04L 67/55

(52) U.S. Cl. CPC H04L 67/52; G01C 21/3484; G01C 21/3694; G08B 5/22; G08B 21/0272; G08B 25/10; H04L 67/55

(57) ABSTRACT

A crowdsourcing method to track and report of aerial vehicles is disclosed. Fusing sensed data from a plurality of mobile devices, made interoperable via systemic software installed on each mobile device, the method collectively and collaboratively provides warning, notification and characterization of one or more unmanned aerial vehicles to law enforcement and/or other responder agencies.

### CROSS REFERENCE TO RELATED APPLICATION

This application claims the benefit of priority of U.S. Pat. No. 11,595,486, issued Feb. 28, 2023, and U.S. non-provisional application number Ser. No. 18/174,946, filed Feb. 27, 2023, as a continuation-in-part thereof, the contents of which are herein incorporated by reference.

### BACKGROUND OF THE SUBJECT DISCLOSURE

The present subject disclosure relates to methods and systems of tracking and reporting airspace activity and, more particularly, to crowd-sourcing the identification and reporting of aerial vehicles.

Reporting and tracking drones are public safety, national security, and airspace management issues that identify and deter dangerous, illegal, or malicious drone activity. Tracking helps authorities locate unauthorized drones near airports, sensitive facilities, and large events, and it enables the recovery of lost drones. Tracking helps prevent drone collisions with aircraft, which could damage engines and cause accidents. Monitoring unauthorized flights in restricted areas like airports and military bases helps deter and prevent illegal activity. Authorities can use drone tracking to respond to threats from drones carrying hazardous materials or being used for malicious purposes. Drone detection technology provides law enforcement with data like the drone's position and movement patterns to help them locate and apprehend pilots who are flying illegally.

In the context of security and military operations, especially within the U.S. Air Force, the Base Defense Operations Center (BDOC) is a command-and-control facility that serves as the focal point for base security and defense. The BDOC functions include planning, directing, integrating, coordinating, and controlling all base defense efforts by serving as an information hub on the base, coordinating responses to emergency and criminal situations, deploying quick reaction forces to address security events. Drone reporting and notifications sent directly to the BDOC, or equivalent command-and-control hubs, regarding suspicious drone activity or other unauthorized intrusions, thereby ensuring rapid response and improved installation and airspace security.

As can be seen, there is a need for a crowd-sourced unmanned aerial vehicle detection and tracking system using distributed mobile device sensors.

### SUMMARY OF THE SUBJECT DISCLOSURE

In one aspect of the present subject disclosure, a crowd-sourced aerial vehicle detection and tracking system having the following components: a plurality of mobile devices, each mobile device comprising: one or more sensors configured to capture sensor data; a processor; a memory storing systemic software comprising executable instructions; wherein execution of said systemic software by said processor configures said mobile device to: monitor sensor data from said one or more sensors to detect presence of the aerial vehicle; capture aerial vehicle tracking data when a aerial vehicle is detected, said aerial vehicle tracking data comprising at least one of: GPS coordinates, timestamp data, altitude estimation, speed data, trajectory data, aerial vehicle size data, or visual data; and transmit said aerial vehicle tracking data over a network; a central processing system includes a aerial vehicle data aggregation module configured to receive aerial vehicle tracking data from said plurality of mobile devices over said network; a data fusion engine configured to process and fuse aerial vehicle tracking data received from multiple mobile devices of said plurality of mobile devices to generate aggregated aerial vehicle tracking information; and a notification engine configured to generate alerts based on said aggregated aerial vehicle tracking information and transmit said alerts to designated recipients.

The system utilizes lookup tables, databases, and the like to ascertain the aerial vehicle make, model, and other characteristics and characterizations in concert with the collected data from, such as but not limited to acoustic sensors (e.g., microphones used to detect the unique acoustic signatures of a drone's motors) and software tools designed to analyze drone imagery and data for identification.

In another aspect of the present subject disclosure, the crowd-sourced aerial vehicle detection and tracking system further includes wherein said one or more sensors of each mobile device comprise at least a video camera and a GPS receiver, and wherein said systemic software is configured to: analyze video frames captured by said video camera using computer vision algorithms to detect moving aerial objects; and when a potential aerial vehicle is detected in said video frames, automatically capture GPS coordinates from said GPS receiver and estimate aerial vehicle altitude, speed, and trajectory based on analysis of said video frames, wherein said systemic software is configured to operate in a passive detection mode wherein sensor data is continuously monitored without requiring active user input, and to automatically transmit aerial vehicle tracking data to said central processing system upon detecting the aerial vehicle, wherein said systemic software is configured to enable a user-initiated aerial vehicle data collection mode, wherein: a user interface displayed on said mobile device enables a user to actively track a detected aerial vehicle using a video camera of said mobile device; and said systemic software captures a live video stream of said aerial vehicle along with real-time sensor data while said user maintains said aerial vehicle within a camera frame, wherein said data fusion engine is configured to: correlate aerial vehicle sightings from multiple mobile devices based on time, location, and visual characteristics; calculate aerial vehicle flight paths and predict future aerial vehicle positions based on said aggregated aerial vehicle tracking information; and identify whether multiple aerial vehicle sightings correspond to a single aerial vehicle or multiple distinct aerial vehicles, wherein said central processing system is configured as a cloud-based platform interoperable with military situational awareness systems, and wherein said alerts transmitted by said notification engine are formatted for display on Base Defense Operations Center (BDOC) dashboards and Android Team Awareness Kit (ATAK) applications and the like known or to be developed in the future.

In yet another aspect of the present subject disclosure, a method for crowd-sourced detection and tracking of aerial vehicles includes the following: distributing systemic software to a plurality of mobile devices over a network, said systemic software configuring each mobile device to function as a distributed aerial vehicle detection node; receiving, by a central processing system, sensor data from said plurality of mobile devices over said network, said sensor data captured by sensors of said plurality of mobile devices and comprising aerial vehicle tracking data including at least one of: GPS coordinates (used for GPS-tagging), timestamp data, altitude data, speed data, trajectory data, aerial vehicle size data, or visual data, wherein said sensor data is captured within a geospatial region at different times by different mobile devices of said plurality of mobile devices; fusing, by a data fusion engine of said central processing system, said sensor data received from multiple mobile devices to generate aggregated aerial vehicle tracking information, said fusing comprising correlating aerial vehicle sightings based on time and location and calculating aerial vehicle flight paths; storing said aggregated aerial vehicle tracking information in a geospatial database with geographic coordinates; analyzing, by a threat analysis module, said aggregated aerial vehicle tracking information to identify aerial vehicle activity patterns and potential security threats; generating, by a notification engine, alerts based on said aggregated aerial vehicle tracking information and said identified potential security threats; and transmitting said alerts to designated recipients comprising at least one of law enforcement agencies, military installations, or emergency response centers.

Aerial vehicles may include unmanned aerial vehicles, including but not limited to drones, manned aircraft, unidentified anomalous phenomena, either current known of developed or identified in the future.

These and other features, aspects and advantages of the present subject disclosure will become better understood with reference to the following drawings, description and claims.

### BRIEF DESCRIPTION OF THE DRAWINGS

FIG. 1 is a schematic view of an exemplary embodiment of the subject disclosure;

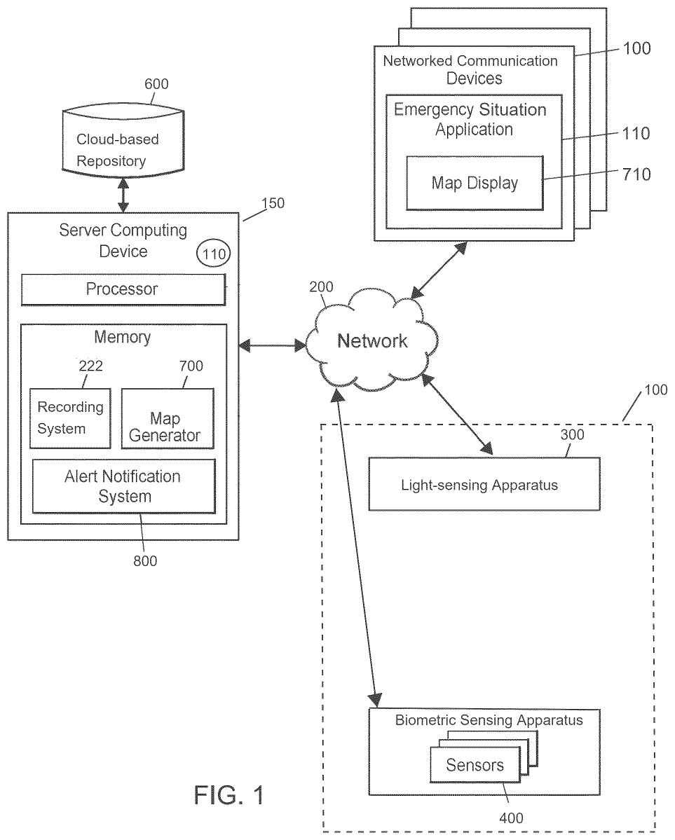

FIG. 2 is a schematic view of an exemplary embodiment of the subject disclosure;

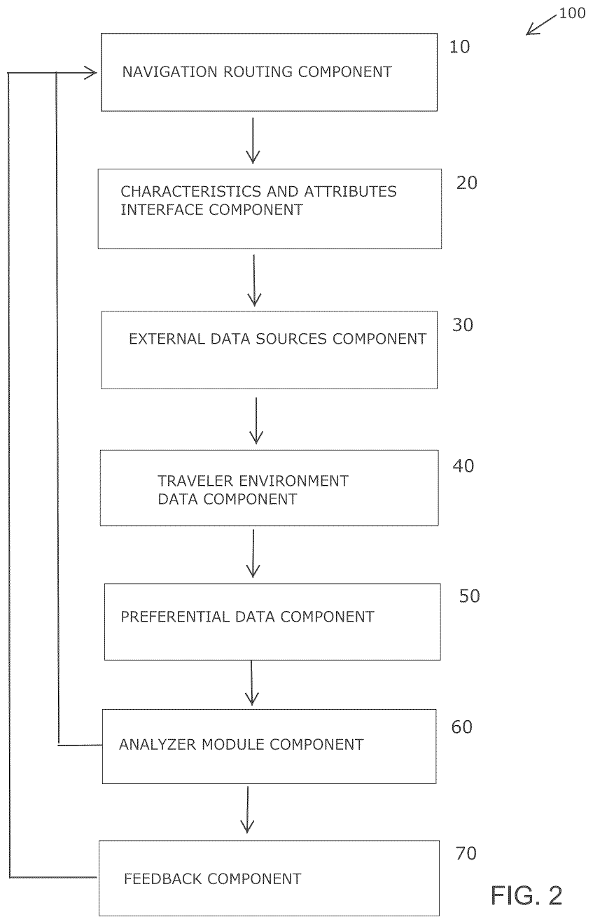

FIG. 3 is a schematic view of an exemplary embodiment of the subject disclosure; and

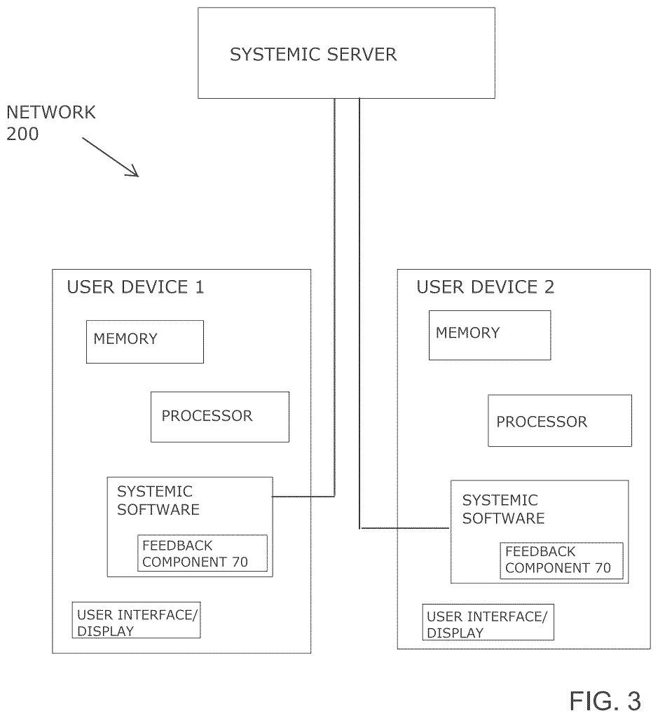

FIG. 4 is a schematic view of an exemplary embodiment of the subject disclosure, illustrating the data path enabled, which in turn improves aerial vehicle monitoring, tracking, and reporting. Specifically, a remote mobile device 100 of the plurality of mobile devices 100 used to (actively) crowdsource aerial vehicles prompts its user(s) to indicate initial human visual and/or audible detection of an aerial vehicle 500. Upon receiving an indication of a nakedly identified aerial vehicle 500, systemic software residing on the mobile device 100 may automatically transition the device 100 to one or more data capture modes (e.g., enabling a microphone and a video camera on the mobile device 100, the latter shown in the Figure on the device's user interface 99). Upon detection of captured images and audio of the aerial vehicle 500 the system automatically renders a map display 720 (either on another or the same mobile device 100) along with an aerial vehicle indicator 550. The aerial vehicle indicator 550 may include characterization data tagged thereto, such as type, size, speed of the aerial vehicle 500, as well as a juxtaposed live-stream video 730 generated by the networked communication mobile device 100, all of which may be embodied in a notification to another networked communication device 100 if an emergency situation is identified.

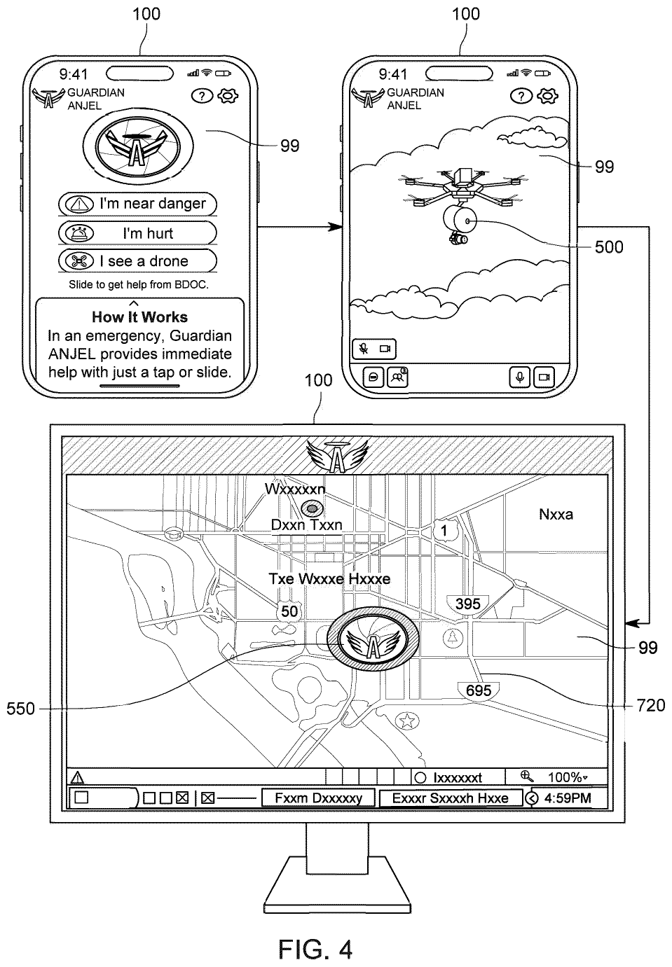

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure includes a collective intelligence system or method for monitoring and reporting unmanned aerial vehicles through a plurality of mobile devices connected over a platform configured to crowdsource or crowdsensing tracking data of aerial vehicles, whereby the system leverages the plurality of mobile devices passively collecting data through sensors to determine the aerial vehicle tracking data. The system also contemplates active collaboration through users of the plurality of mobile devices contributing data.

The collective intelligence system for monitoring and reporting aerial vehicles may include systemic software installed on each mobile device of the plurality of mobile devices. The system includes receiving, by a processing system over a network from the plurality of mobile devices via the systemic software, sensor data captured by one or more sensors of the plurality of mobile devices, the sensor data including aerial vehicle tracking data. The processing system may reside on the systemic platform configured as a cloud-based, geospatially enabled data recording, notification, and rendering system.

One or more aspects of the subject disclosure include a non-transitory machine-readable medium, comprising executable instructions that, when executed by a processing system, including a processor, facilitate performance of operations. The operations include the platform receiving, over a network from a plurality of mobile devices via the systemic software, sensor data captured by one or more sensors of the plurality of mobile devices, the sensor data includes aerial vehicle tracking data, such as but not limited to date/time, GPS-tagged live images and video capture, real-time geographical coordinates, altitude/elevation, actual ground speed, and trajectory, aerial vehicle type and equipment, aerial vehicle size and aerial vehicle dimensions of moving aerial objects sensed by the plurality of sensors, wherein the sensor data is captured within a particular geospatial region at different times by different mobile devices of the plurality of mobile devices. The operations include providing, over the network, sensor data to an aerial vehicle reporting server to enable generation of a graphical representation of the sensed aerial vehicles through specialized software applications and digital mapping platforms like Google Earth, GIS software or the like.

In a nutshell, the system through, at least in part, the fusion engine identifies the geospatial location of the mobile device using its meta data (e.g., directional and geospatial sensors, and other data sets pertaining to its geolocation) so that when combined with that mobile device's captured images of the aerial vehicle, uses triangulation to track the aerial vehicle. Other data collection devices may include motion sensors, such as but not limited to an accelerometer, which detects acceleration and orientation changes to measure movement; gyroscope, which measures rotational movement and angular velocity; position sensors; magnetometer, which detects magnetic fields for compass and navigation; geomagnetic field sensor, which provides data for orientation; GPS, which determines the device's geographical location; environmental sensors; ambient light sensor, which adjusts screen brightness based on surrounding light; proximity sensor, which turns off the screen when the phone is held to the ear during a call; barometer, which measures atmospheric pressure to help determine altitude thermometer, which monitors the device's internal temperature. Other data collection devices include biometric and security sensors; fingerprint sensor, which unlocks the device for security; face/iris recognition sensors, which are used for secure authentication; imaging and optical sensors; image sensor, which captures images and videos; Time-of-flight (ToF) sensor, which measures distance, often used for portrait mode effects; heart rate sensor, which monitors pulse; SpO₂ sensor. Which measures blood oxygen saturation and NFC sensor, which enables contactless communication for features like mobile payments.

System can include mobile devices, such as smart phones, IoT devices or other mobile devices including laptops, wearable devices, and so forth. The mobile devices can communicate utilizing various wireless technologies or combinations of technologies including cellular communications, WiFi, UWB, Bluetooth®, and so forth. System can also include one or more servers that can operate to generate, store (e.g., in an aerial mapping repository), update, aggregate with other data and/or maps, distribute, and/or otherwise manage.

In one or more embodiments, logic and methodology can be added to the systemic software to leverage disparate sensor data from a plurality of mobile devices to automatically determine the aerial vehicle tracking data through fusing said disparate sensor date. In one embodiment, the mobile device can be a smart phone wherein the systemic software enables a aerial vehicle data collection mode that utilizes the video camera of the mobile device to identify a target aerial vehicle.

In one or more embodiments, individual aerial vehicle tracking data files (which may have been collected by different devices at different times utilizing different collection servers and which may include overlapping aerial vehicle tracking data) which can be stitched together which will allow a operation central network to build an aggregated tracking mapping database on behalf of public safety. The systemic software would use the power of crowd sourcing to scale an aggregated database of aerial vehicle tracking and mapping. This service can be beneficial to operational center network users.

In one or more embodiments, the systemic software operates in a passive detection mode wherein sensor data from the mobile device is continuously or periodically monitored without requiring active user input. Logic and methodology within the systemic software leverages disparate sensor data from the plurality of sensors to automatically detect and characterize aerial vehicles.

For example, the video camera may capture image frames that are analyzed using computer vision algorithms to detect moving aerial objects. when a potential aerial vehicle is detected in the video feed, the systemic software automatically: captures GPS coordinates from the GPS receiver, records timestamp data, estimates aerial vehicle altitude using triangulation or other estimation techniques, determines aerial vehicle speed and trajectory by analyzing movement across successive video frames, characterizes aerial vehicle type, size, and dimensions through image analysis, and packages all captured data as a aerial vehicle tracking data file transmits the aerial vehicle tracking data file over the network to the central processing system.

In one embodiment, the systemic software enables a aerial vehicle data collection mode that can be actively initiated by a user. When activated, the mobile device utilizes the video camera to identify a target aerial vehicle. The user interface may display targeting reticles or other visual indicators to assist the user in tracking the aerial vehicle with the camera. As the user maintains the aerial vehicle within the camera frame, the systemic software continuously captures sensor data including: Live video stream of the aerial vehicle, GPS coordinates of the mobile device and estimated coordinates of the aerial vehicle, real-time altitude and elevation data, actual ground speed calculations, trajectory analysis, and time-stamped metadata.

The user may optionally provide additional input through the user interface, such as: estimated aerial vehicle type or model, observed equipment or payloads, direction of travel, voice annotations recorded through the microphone.

When the central processing system receives aerial vehicle tracking data from multiple mobile devices, the data fusion engine processes the disparate data to create comprehensive tracking profiles. Individual aerial vehicle tracking data files (which may have been collected by different devices at different times utilizing different collection servers and which may include overlapping aerial vehicle tracking data) are stitched together to build an aggregated tracking mapping database.

The data fusion engine may employ algorithms to: correlate aerial vehicle sightings from multiple mobile devices based on time, location, and visual characteristics, triangulate aerial vehicle position using multiple GPS-tagged observations, calculate flight paths and predict future positions, identify unique aerial vehicles versus multiple sightings of the same aerial vehicle, estimate aerial vehicle capabilities based on observed flight characteristics, detect patterns in aerial vehicle activity over time and across geographic regions. This data fusion capability allows the central processing system to build an aggregated database of aerial vehicle tracking and mapping that leverages the power of crowdsourcing to scale beyond what individual sensors could accomplish.

Upon detecting aerial vehicle activity, particularly in restricted or sensitive areas, the notification engine generates alerts that are transmitted to designated recipients. The system may be configured with geofenced zones corresponding to airports, military installations, government facilities, critical infrastructure, and other protected areas. When aerial vehicle activity is detected within or approaching these zones, priority alerts are generated.

For military installations, alerts may be transmitted directly to the Base Defense Operations Center (BDOC) dashboard with real-time geolocation of the detected aerial vehicle, live video stream from detecting mobile devices, estimated threat level based on aerial vehicle characteristics and behavior, and recommended response actions.

The notification system supports secure communications protocols and may be interoperable with existing defense communication platforms including Cloud One and Android Team Awareness Kit (ATAK), enabling seamless integration with military and government agency situational awareness systems.

A visualization module may generate graphical representations of aerial vehicle tracking data that can be displayed through web-based dashboards accessible by authorized users, mobile applications on authorized devices, integration with existing GIS platforms, specialized mapping software such as Google Earth. real-time operational displays at security operations centers. Visualizations may include color-coded aerial vehicle tracks showing historical flight paths, predictive trajectory projections, geofenced restricted zones, and responding agency positions and resources.

In one embodiment of the subject disclosure, a mobile emergency reporting application and BDOC dashboard with secure communications, geolocation tracking, live video, and drone/UAS reporting are provided. These functionalities are interoperable with central platform for various defense applications and data (e.g., “Cloud One”) and smartphone geospatial infrastructure and situational awareness applications used by military and other government agencies for navigation, coordination, and data sharing, including but not limited to Android team Awareness Kit (ATAK). The subject disclosure may include a serverless, scalable, cloud-native platform, and may augment legacy voice-only 911.

In sum, the systemic software (colloquially known as Guardian ANJEL) transforms smartphones into real-time ISR reporting tools for installation security. Its integration of geolocation, video streaming, and encrypted chat yields 20% for enabling faster emergency response. The subject disclosure enables installation resilience and enhanced command-and-control in support of JADC2 and homeland defense operations. Thereby, the subject disclosure supports detection and reporting of unauthorized drone activity through GPS-tagged live video and real-time BDOC alerts—addressing emerging C-UAS gaps.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the subject disclosure and that modifications may be made without departing from the spirit and scope of the subject disclosure as set forth in the following claims.

What is claimed is:

1. A crowd-sourced aerial vehicle detection and tracking system, comprising:
a plurality of mobile devices, each mobile device comprising:
one or more sensors configured to capture sensor data;
a processor;
a memory storing systemic software comprising executable instructions; wherein execution of said systemic software by said processor configures said mobile device to:
monitor sensor data from said one or more sensors to detect presence of a aerial vehicle;
capture aerial vehicle tracking data when the aerial vehicle is detected, said aerial vehicle tracking data comprising at least one of: GPS coordinates, timestamp data, altitude estimation, speed data, trajectory data, aerial vehicle size data, or visual data; and
transmit said aerial vehicle tracking data over a network;
a central processing system comprising:
a aerial vehicle data aggregation module configured to receive aerial vehicle tracking data from said plurality of mobile devices over said network;
a data fusion engine configured to process and fuse aerial vehicle tracking data received from multiple mobile devices of said plurality of mobile devices to generate aggregated aerial vehicle tracking information; and
a notification engine configured to generate alerts based on said aggregated aerial vehicle tracking information and transmit said alerts to designated recipients.

2. The system of claim 1, wherein said one or more sensors of each mobile device comprise at least a video camera and a GPS receiver, and wherein said systemic software is configured to:
analyze video frames captured by said video camera using computer vision algorithms to detect moving aerial objects; and
when a potential aerial vehicle is detected in said video frames, automatically capture GPS coordinates from said GPS receiver and estimate aerial vehicle altitude, speed, and trajectory based on analysis of said video frames.

3. The system of claim 1, wherein said systemic software is configured to operate in a passive detection mode wherein sensor data is continuously monitored without requiring active user input, and to automatically transmit aerial vehicle tracking data to said central processing system upon detecting the aerial vehicle.

4. The system of claim 1, wherein said systemic software is configured to enable a user-initiated aerial vehicle data collection mode, wherein:
a user interface displayed on said mobile device enables a user to actively track a detected aerial vehicle using a video camera of said mobile device; and
said systemic software captures a live video stream of said aerial vehicle along with real-time sensor data while said user maintains said aerial vehicle within a camera frame.

5. The system of claim 1, wherein said data fusion engine is configured to: correlate aerial vehicle sightings from multiple mobile devices based on time, location, and visual characteristics;
triangulate aerial vehicle position using GPS-tagged observations from said multiple mobile devices;
calculate aerial vehicle flight paths and predict future aerial vehicle positions based on said aggregated aerial vehicle tracking information; and
identify whether multiple aerial vehicle sightings correspond to a single aerial vehicle or multiple distinct aerial vehicles.

6. The system of claim 1, wherein said central processing system is configured as a cloud-based platform interoperable with military situational awareness systems, and wherein said alerts transmitted by said notification engine are formatted for display on Base Defense Operations Center (BDOC) dashboards and Android Team Awareness Kit (ATAK) applications.

7. A method for crowd-sourced detection and tracking of aerial vehicles, comprising:
distributing systemic software to a plurality of mobile devices over a network, said systemic software configuring each mobile device to function as a distributed aerial vehicle detection node;
receiving, by a central processing system, sensor data from said plurality of mobile devices over said network, said sensor data captured by sensors of said plurality of mobile devices and comprising aerial vehicle tracking data including at least one of:
GPS coordinates, timestamp data, altitude data, speed data, trajectory data, aerial vehicle size data, or visual data, wherein said sensor data is captured within a geospatial region at different times by different mobile devices of said plurality of mobile devices;
fusing, by a data fusion engine of said central processing system, said sensor data received from multiple mobile devices to generate aggregated aerial vehicle tracking information, said fusing comprising correlating aerial vehicle sightings based on time and location and calculating aerial vehicle flight paths;
storing said aggregated aerial vehicle tracking information in a geospatial database with geographic coordinates;
analyzing, by a threat analysis module, said aggregated aerial vehicle tracking information to identify aerial vehicle activity patterns and potential security threats;
generating, by a notification engine, alerts based on said aggregated aerial vehicle tracking information and said identified potential security threats; and
transmitting said alerts to designated recipients comprising at least one of law enforcement agencies, military installations, or emergency response centers.
